(19) United States
(12) Patent Application Publication
(10) Pub. No.: US 2011/0257314 A1
(43) Pub. Date: Oct. 20, 2011

(54) SOIL SOLIDIFIER AND RELATED METHODS

(75) Inventors: Joanna Oat, Ledyard, CT (US); Adrian de Krom, Newbury, OH (US); Robert M. Shaw, JR., Independence, OH (US)

(73) Assignee: SB Industries, LLC, Ledyard, CT (US)

(21) Appl. No.: 13/088,770

(22) Filed: Apr. 18, 2011

Related U.S. Application Data
(63) Continuation-in-part of application No. 12/761,999, filed on Apr. 16, 2010.

(51) Int. Cl. C08K 13/02; C08L 25/14; C08K 3/28; C08K 5/5425; C08K 5/42

(52) U.S. Cl. 524/161; 524/264

(57) ABSTRACT

A method for constructing a structure, preferably a swimming pool, includes the steps of excavating a cavity, applying a sub-base such as sand along at least a portion of the cavity, forming the sub-base into the desired shape of the structure, and applying a solidifier solution to the sub-base. The solidifier solution comprises a polymer in solution. The solidifier solution and the sub-base harden to form a smooth, hard composite layer in the base of the cavity, with the composite layer containing at least some of the polymer and at least some of the sub-base in a polymer lattice. After the solidifier solution has been applied, a liner may be installed, and the swimming pool may be filled. Additionally, the solidifier solution may be applied directly to the cavity, or to masonry or other materials, and may be used to construct any applicable structure.

### CROSS-REFERENCE TO RELATED APPLICATIONS

This application is a continuation-in-part of U.S. patent application Ser. No. 12/761,999, filed Apr. 16, 2010, the contents of which are incorporated herein by reference in their entirety.

### BACKGROUND OF THE INVENTION

1. Field of the Invention

The present invention relates to systems and methods for installing structures at or below earth grade. More particularly, the present invention relates to the use of improved materials and methods to install structures at or below earth grade, such as swimming pools, in order to provide an improved interface between the structure and the soil in situ.

2. Description of the Related Art

Due to the changing and sometimes unpredictable nature of soil, installing structures on or beneath the surface of the Earth can be a challenge. In its natural state, soil may comprise three phases, including air, solids and water. Generally, soil solids may include any combination of sands (such as particles typically ranging in diameter from 0.05 millimeters to 2.0 millimeters), silts (such as particles ranging in diameter from 0.002 mm to 0.05 mm), and clays (such as particles less than 0.002 mm in diameter). Soil density and strength can differ greatly due to any number of factors, including the composition and orientation of the soil solids, the ratio of voids within the soil, the moisture content of the soil and the temperature, both of the soil and of the surrounding environment. The density and strength of soil in a particular location may also change over time, for example, due to variations in loading in the surrounding area, shifting of the water table, or other independent factors. Therefore, when constructing or installing a structure at or below grade level, successfully manipulating the interface between the structure and the soil may save time and money both during construction and throughout the life of the structure, and lead to improved quality, strength and durability of the structure as a result.

The ever-shifting nature of soil is particularly relevant to swimming pools, which may have relatively few component parts and relatively small masses when compared to other structures, but can require the excavation of several dozen cubic yards of soil. Swimming pools generally include “pool sidewalls,” or the vertical or substantially vertical portions located generally along the perimeter of the pool, and “pool bottoms,” or the non-vertical or substantially non-vertical portions such as the flat bottom or angled sides of a pool. Pool bottoms, and portions of pool sidewalls which extend even slightly below grade, are subject to the constantly shifting and reactive nature of soil. Because soil density and strength can change over time, pools should be installed and filled as quickly as possible after the shapes of their pool bottoms have been formed. A filled pool relies on hydrostatic pressure from the weight of the water to help to maintain its shape against potentially shifting soil. However, an empty pool is subject to potentially varying conditions in the underlying and surrounding soil, which may cause even well-formed pool surfaces to deform or fracture, requiring added work or repairs in order to complete the construction of the pool. Therefore, pool designers and installers must consider and accommodate the interface between a pool and the soil during both installation and use of the pool.

A number of materials and procedures have been utilized to address the uncertain nature of soils beneath and around a swimming pool. For example, swimming pools have been constructed from cement or concrete. These materials can include a cement mix, water, aggregate and/or sand, and can provide excellent strength in compression and against the various pressures associated with shifting or changing soils. However, constructing a pool from cement and/or concrete may be expensive, hazardous and potentially harmful to the environment. Using cement and/or concrete in pools requires the purchase and delivery of cement mix and other materials, such as steel reinforcing bars, to the pool site, and additional landscaping materials may also be necessary if the pool is installed partially above grade. Mixing, pouring and spraying cement and/or concrete also requires additional manual labor and/or equipment, and workers must wear protective clothing such as vests, gloves and/or goggles when working with cement and/or concrete, to protect themselves from burns caused by acids in the liquid cement or heat which may be released during mixing.

Moreover, cement-bottomed pools are not immune to some of the problems associated with shifting or changing soils. For example, standard cements are typically impermeable to water, and a cement pool bottom in an unfilled pool can “float,” or “lift” up from the ground, due to soil pressures on the bottom and side surfaces of the pool, which may cause some or all of the pool bottom to crack or even shear. For this reason, many cement or concrete pools are installed slightly above-grade to reduce or minimize the hydrostatic pressure beneath and around the pool bottom during installation, and are filled in with backfill or other landscaping materials around the pool perimeter after the pool has hardened.

Vermiculite, a naturally occurring mineral, has been mixed with Portland cement and used to construct pools with hard, smooth pool bottoms. However, the use of vermiculite includes many of the same challenges that are typically associated with concrete, in that vermiculite is relatively expensive and requires the purchase and delivery of materials to the site, and also requires additional labor and equipment for construction. Moreover, a pool bottom made with vermiculite can take several days to harden, which delays the construction process. The cost of such delays is borne by the buyer.

Sand-bottomed pools are another common alternative to concrete or vermiculite, as sand provides a cheaper means for forming a pool bottom, and has excellent permeability to water. Sand-bottomed pools are not subject to the “lifting” or “float” that can plague cement-bottomed or concrete-bottomed pools. Additionally, a sand-bottomed pool may be constructed at a fraction of a cost of a cement-bottomed pool or a vermiculite-bottomed pool.

A sand-bottomed “in ground” swimming pool is traditionally installed according to the following general procedure. First, the desired pool location is identified and evaluated for its suitability. Next, a sufficiently large volume of earth is excavated from the location by manual or mechanical means, leaving behind raw, disturbed earth at the bottom of a soil basin. The disturbed earth may be roughly formed into the desired shape of the pool, including the approximate depths and perimeter of the pool. Pool sidewalls may then be framed and installed to mark the vertical or substantially vertical portions of the pool perimeter, while the pool bottom remains earthen. Pool sidewalls can be made of any suitable building materials, including fiberglass, wood, steel, concrete, or others, and may include foam or other padding materials, as desired.

After the excavation is complete and the pool sidewalls have been installed, sand may then be shoveled, or poured into the earthen basin along the pool bottom. Traditional sand-bottomed pools require a layer of sand approximately three to four inches thick (3″-4″) along the pool bottom. Once the sand has been placed into the earthen basin, the sand may be more finely shaped to correspond to the ultimately desired form of the finished pool bottom, by manual or mechanical means, such as with a hand trowel. During installation, the moisture content of the sand may be altered as necessary by adding water, such as with a hose, to facilitate the forming of the sand into the desired form of the pool bottom.

After the sand layer has been applied and smoothed along the pool bottom, a liner is inserted, or dropped, into the completed pool frame. The liner typically descends from at or near the top of the pool sidewalls and down into the basin atop the pool bottom, and should be evenly smoothed along the pool sidewalls and pool bottom so as to minimize the number and size of wrinkles or creases. After the liner has been installed, the pool is complete, and may be filled with water immediately. Once the pool is filled, hydrostatic pressure from the water in the pool liner helps to maintain the form and shape of the pool bottom.

The foregoing procedure for installing a sand-bottomed “in ground” swimming pool is similar to that for use in installing a sand-bottomed “above ground” pool. For an “above ground” pool, the sand is typically applied to the excavated area prior to erecting the pool sidewalls, and is then spread into the desired form of the pool bottom after the pool sidewalls have been installed. In most respects, however, the procedures for installing an “above ground” swimming pool are similar to those for installing an “in ground” swimming pool. Moreover, the foregoing procedures may be modified as necessary to construct either a sand-bottomed “in ground” pool or a sand-bottomed “above ground” pool.

Sand-bottomed pools provide significant advantages over pools with bottoms made of cement, vermiculite or other materials, in terms of cost savings and the reduced time required for assembly. However, one of the most significant disadvantages of sand is its lack of independent structural strength. During installation, a sand pool bottom may be subject to creep before the liner is installed and the pool is filled, because sand-bottomed pools rely on the hydrostatic pressure provided by the filled liner to maintain their shape. During use, a sand pool bottom may shift or settle over time, due to washouts, depressions, water veins in or through the sand base beneath it, or as pressure is applied above from footprints or other sources. Sand is also subject to infiltration by bugs, moles or other critters, which can damage the pool liner and threaten the pool's integrity. Additionally, because pool liners typically must be replaced over time, the difficulties associated with building a traditional sand-bottomed pool can be encountered every time a pool liner requires replacement.

It is an object of the present invention to overcome one or more of the drawbacks and/or disadvantages of the prior art described above.

### SUMMARY OF THE INVENTION

The present invention is directed to an improved method for installing structures, such as swimming pools, into or onto soil. The present invention is also directed to an improved arrangement for a structure, such as a swimming pool, that is installed into or onto soil. The present invention is further directed to a solidifier solution that may be used to solidify or plasticize materials, such as soil, for any reason. Field testing of the compounds and methods disclosed herein have demonstrated that standard structures, such as sand-bottomed swimming pools, may be installed more quickly and easily than according to currently known methods.

In accordance with a first aspect, the present invention is directed to an improved method for constructing structures, such as swimming pools, into or onto soil. A preferred method may comprise the steps of excavating a cavity to expose a base layer; shaping a basin of a predetermined shape within the cavity; and applying a solidifier solution to the basin within the cavity. Preferably, the solidifier solution comprises an aqueous polymer, and the aqueous polymer and at least a portion of the base or the sub-base combine to form a composite layer comprising the polymer and at least a portion of the sub-base in a polymer lattice. In accordance with another aspect, a method may further comprise applying a sub-base layer onto the base layer within the cavity, and shaping the sub-base layer into a basin prior to applying the solidifier solution to the sub-base layer. Preferably, the base layer comprises soil, and the sub-base layer primarily comprises sand. The base layer and sub-base layer may include any appropriate materials, however, including but not limited to soil of any composition, sand or any appropriate substitutes for soil or sand. Additionally, the solidifier solution may be applied directly to sand, to soil of any composition, or to any applicable material according to the present invention.

In accordance with another aspect, the present invention is directed to a structure, such as a swimming pool, comprising a base layer and a composite layer. According to one embodiment, the present invention is directed to a pool comprising a base layer, a sub-base layer and a composite layer. The base layer may include, for example, a soil of any type or composition. The sub-base layer may comprise primarily sand. The composite layer may include a polymer and at least a portion of the sub-base in a polymer lattice, and may be formed, for example, from an aqueous solution containing such a polymer, mixed with at least some of the sub-base layer. The composite layer may be formed following the application of a solidifier solution to a base layer such as soil or, preferably, to a soil consisting primarily of sand.

In accordance with yet another aspect, the present invention is directed to a solidifier solution for use in the construction of a structure, such as a swimming pool, into or onto soil. A solidifier solution according to the present invention may be a fast-curing binder solution that may be applied to a material such as sand, in order to impart strength to the material and to form a smooth polymer-based composite layer that can harden in a relatively short period of time. According to another embodiment of the present invention, the solidifier solution may comprise a polymer. According to another embodiment of the present invention, the solidifier solution may comprise a polymer and a surfactant. According to another embodiment of the present invention, the solidifier solution may comprise a polymer, a cross-linking agent, and a surfactant, which are combined by mixing. According to a currently preferred embodiment, the polymer is an aqueous emulsion polymer solution.

According to one embodiment of the present invention, one preferred polymer for use in the solidifier solution is an acrylate emulsion polymer in solution. According to another embodiment of the present invention, the solidifier solution may comprise styrene acrylate. According to one embodiment of the present invention, the polymer may be formed from monomers, such as styrene acrylate and n-butyl acrylate. According to another preferred embodiment of the present invention, the solidifier solution is sufficiently viscous and may be applied by spraying, such as onto sand.

The compounds and methods of the present invention provide a number of advantages over the prior art. For example, applying a solidifier solution according to the present invention to soil may result in a hard, smooth bottom for a structure, such as a swimming pool, less expensively and more efficiently than according to prior art methods, such as those prior art methods which utilize cement, concrete or vermiculite. The use of a solidifier solution can also reduce or eliminate the need to buy, transport and/or mix certain products, and thus reduce the cost, equipment and manual labor required to construct the pool. Additionally, structures that are constructed with a composite layer comprising a polymer and at least a portion of the sub-base in a polymer lattice using the compounds and/or methods of the present invention may save money and resources over time. In the particular example of a swimming pool constructed using the compounds and/or methods of the present invention, replacing a pool liner in the future may be performed more quickly and easily, because the pool bottom should remain in substantially the same form that was established during the initial installation.

In addition to swimming pools, which generally contain standing water, the compounds and methods disclosed herein may be used to construct or improve other water features, such as irrigation channels, drainage paths or ducts, ponds, estuaries, moats or any other applications designed to accommodate flowing or standing water. Moreover, the compounds and methods disclosed herein may also be utilized to construct or improve a variety of other permanent or semi-permanent structures which require an interface with soil, such as cofferdams, slabs, footings, sidewalks, streets, highways and the like. In addition to sand, the solidifier solutions of the present invention may also be applied to an unlimited number of materials, such as soils of any composition. For example, the solidifier solutions of the present invention may be applied to masonry, stones, concrete, pavement or other surfaces to provide greater durability and protection, as well as a smooth, high-sheen surface texture. The solidifier solution may also be included as an ingredient in other mixes, such as cement mixes, to provide a harder, stronger finished product.

Other aspects and advantages of such structures, compounds and methods may be determined upon review of the Summary of the Invention, Figures, Detailed Description and Claims.

### DESCRIPTION OF THE SEVERAL VIEWS OF THE INVENTION

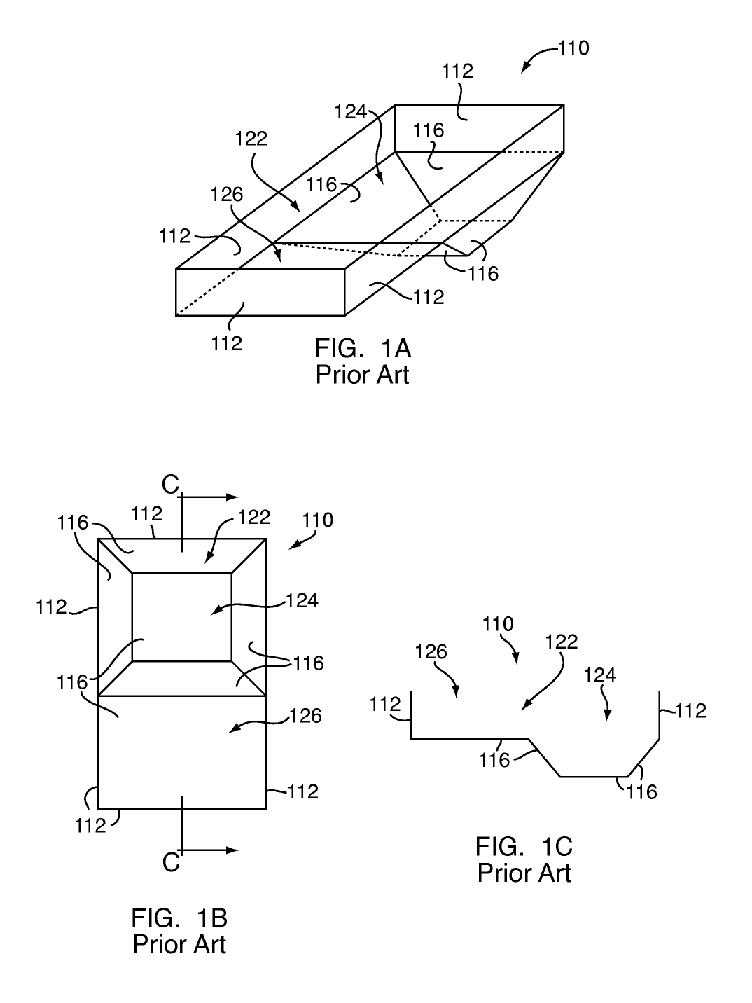

FIG. 1A is a front perspective view of an “in ground” swimming pool according to the prior art.

FIG. 1B is a top view of the swimming pool of FIG. 1A.

FIG. 1C is a cross-sectional view of the swimming pool of FIG. 1B, taken along lines C-C.

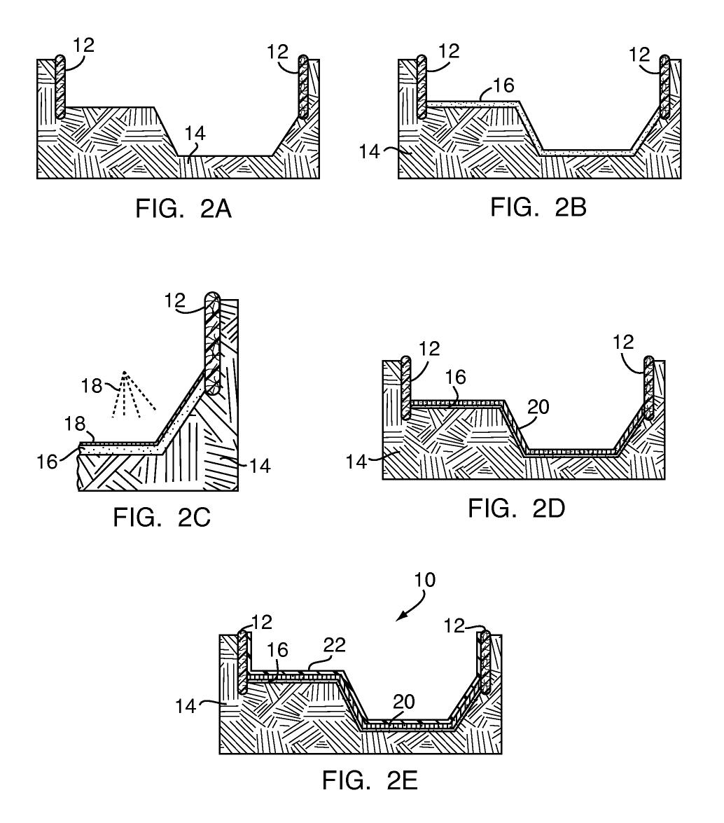

FIGS. 2A through 2E show various steps of a method for installing a structure according to an embodiment of the present invention.

### DETAILED DESCRIPTION OF THE INVENTION

In FIG. 1A, a perspective view of a swimming pool according to the prior art is indicated generally by the reference numeral 110. The pool 110 shown in FIG. 1 includes pool sidewalls 112, faces of a pool bottom 116 and a pool liner 122. The pool sidewall 112 includes a plurality of substantially vertical portions or faces around the perimeter of the pool 110. The pool bottom 116 includes a plurality of substantially non-vertical, or substantially horizontal and/or tapered portions. The pool liner 122 covers the inside lining of the pool sidewalls 112 and the pool bottom 116. The pool liner 122 shown in FIG. 1A defines a cavity, but is not filled with water. The pool 110 shown in FIG. 1A also defines a deep end 124 where the depth of the pool is at its greatest, and a shallow end 126 where the depth of the pool is at its least.

In FIG. 1B, a top view of the swimming pool 110 of FIG. 1A is shown. In FIG. 1C, a side view of the swimming pool 110 taken along section lines C-C of FIG. 1B is shown.

A method for installing a structure into or onto soil according to one embodiment of the present invention is described below and shown in FIGS. 2A-2F, for the particular example of an “in ground” swimming pool. An excavation is performed in the vicinity of the desired location for the pool, revealing a cavity lined with a base 14 of raw, disturbed earth, as is shown in FIG. 2A. Next, pool sidewalls 12 may be installed to provide lateral support against the disturbed soil base 14 and to delineate the perimeter of the desired structure, as is also shown in FIG. 2A. Pool sidewalls 12 are typically installed in a vertical or substantially vertical orientation, and may be made of any suitable building materials, such as wood, steel, fiberglass, or the like.

Next, a layer of sub-base 16, such as sand, is placed into the cavity. As is shown in FIG. 2B, the sub-base 16 is shaped into the ultimately desired form of the pool bottom. The sub-base 16 may be shaped by hand, rake or trowel, or by mechanical means. Concrete sand or brick sand are the preferred sub-bases 16 to be utilized in accordance with the methods of the present invention, although any particular sand or sand substitute may be used. Additionally, water may be added to the sub-base 16 as necessary, to temporarily increase the viscosity or formability of the sub-base 16 during shaping.

After the sub-base 16 has been properly shaped into the desired form of the pool bottom, a solidifier solution 18 may be applied to the sub-base 16, such as by spraying, for example, with a hose, pump or aerosol container. FIG. 2C shows a solidifier solution 18 being applied to a portion of a sub-base 16, in accordance with the principles of the present invention. The sub-base 16 should be slightly wet with a consistent moisture content throughout at the time the solidifier solution 18 is applied. The combined solidifier solution 18 and sub-base 16 mixture may then be further mixed, raked, and shaped before being finally smoothed or finished, such as with a hand trowel. After a short period of time, the solidifier solution 18 and at least a portion of the layer of sub-base 16 form a permanent or semi-permanent composite layer 20, comprising a polymer and a sand in a polymer lattice, substantially conforming with the formed shape of the sub-base 16, as is shown in FIG. 2D. For pools with uneven pool bottoms, such as pools with both a deep end and a shallow end, as is shown in FIGS. 1A-1C and FIGS. 2A-2E, it is recommended that the solidifier solution 18 be applied to the area of the pool bottom that is most shallow first, before moving into the area that is most deep. The solidifier solution 18 may be applied to the sub-base 16 in any order, however, in accordance with the principles of the present invention. Moreover, the pool bottom need not have planar features, and may be formed into parabolic or other curved shapes.

As is shown in FIG. 2E, after the solidifier solution 18 is applied to the sub-base 16, a liner 22 is dropped into the pool and mounted to the sides along the perimeter. The liner 22 may be dropped into the pool at any time, either while the solidifier solution 18 and the sub-base 16 are still hardening into the composite layer 20, or after the composite layer 20 has completely hardened. The liner 22 may then be smoothed to remove any wrinkles or creases. Once the liner 22 is installed, the construction of the pool 10 is generally complete, and the pool 10 should be filled with water as soon as possible to ensure that the hydrostatic pressure of the filled pool 10 assists in maintaining the form of the pool bottom and curing the composite layer 20.

The foregoing methods for installing a swimming pool may be modified as necessary to include various stylistic or architectural features such as ladders, slides, stairs, or waterfalls, or functional equipment or service connections including lighting, heating or filtration systems, consistent with the principles of the present invention. For example, a ladder or set of stairs may be added to the pool as the sidewalls 12 are constructed, and may be formed integrally with the sidewalls 12. Components of a filtering system (such as a drain) may be installed into the sidewalls 12 or placed into the earthen basin before installing the sub-base 16, and the shaped sub-base 16 may then be smoothed around the drain. The shape of the pool 10 need not be rectangular or even regular, and the desired form of the pool bottom may be entirely flat, or may have no horizontal portions at all. Additionally, the foregoing methods for installing a swimming pool may be modified for use in the construction of other structures into or onto soil, such as a cofferdams, slabs, footings, sidewalks, streets, highways or the like, wherein maintaining a form of sand or soil is desired.

The solidifier solution 18 may be applied to a layer of base 14 such as soil, or a layer of sub-base 16 such as sand, after the base 14 or sub-base 16 has been shaped into a desired form of the pool bottom. Moreover, the base 14 or sub-base 16 layers may be further mixed or shaped after the solidifier solution 18 has been applied thereto. For the particular example of a sand-bottomed pool, unlike prior art methods, the methods according to the present invention preferably require a layer of approximately one to two inches (1-2″) of sand, or approximately half the preferred depth of sand that is required according to prior art methods.

Preferably, the solidifier solution 18 is applied to the layer of sub-base 16, such as sand, and then mixed and shaped before being permitted to harden. The solidifier solution 18 and the sub-base 16 form a hard, smooth and durable composite layer 20 that enables the pool to retain its desired shape during the installation process and throughout use. The composite layer 20 comprises a polymer and at least some of the sub-base 16, such as sand, interspersed within a polymer lattice.

A composite layer 20 of the present invention may be formed, for example, using a solidifier solution 18 containing an aqueous emulsion polymer solution, which encompasses and becomes imbued with at least a portion of the layer of sub-base 16, such as sand, which then becomes an integral part of the composite layer 20. After applying the solidifier solution 18 to the sub-base 16, the resulting liquid or semi-liquid form is a mixture that hardens into a hard, smooth composite layer 20 at the pool bottom, without the equipment, expense or effort associated with cement, concrete or vermiculite.

According to a preferred embodiment, the solidifier solution 18 comprises a polymer and a cross-linking agent and, optionally, a surfactant. Preferably, the polymer is an emulsion polymer in solution, with approximately fifty percent (50%) polymer solids in solution, and the resulting composite layer 20 comprises a latex formed by the hardened emulsion polymer and at least a portion of the sub-base 16, such as sand. The emulsion polymer in solution preferably has carboxylic acid functionality, based on carboxylic acid functional groups incorporated therein. A preferred example of a polymer for use in the solidifier solution 18 is a styrene acrylate copolymer, which may be formed in a variety of ways. Some materials which may be used to form an appropriate styrene acrylate copolymer may include, for example, an acrylic acid ester, such as n-butyl acrylate, and alpha-methylstyrene. Additionally, other polymers which may be used in solidifier solutions 18 of the present invention may include vinyl acetates, for example.

A cross-linking agent is preferably included in the solidifier solutions 18 of the present invention. A cross-linking agent may accelerate the hardening rate of the polymer, or enhance its carboxylic acid functionality. Cross-linking agents promote the formation of intermolecular bonds between strands of the polymer as the solidifier solution 18 hardens with the sub-base 16, thereby increasing the molecular weight of the resulting composite layer 20 and forming a harder, more rigid polymer lattice. Although a cross-linking agent is not an essential ingredient in the solidifier solutions 18 of the present invention, the hardening rate of a solidifier solution 18 is controlled by the self-cross-linking properties of the aqueous polymer alone if the solidifier solution 18 lacks a cross-linking agent. Without a cross-linking agent, both the drying rate of the solidifier solution 18 and the hardness of the composite layer 20 ultimately formed with the sub-base layer 16 may be less desirable, however.

Preferable cross-linking agents for use in the present invention include forms of divalent metals, such as zinc or calcium, in solution. One preferable aqueous cross-linking agent is a basic zinc oxide solution. Other cross-linking agent solutions and cross-linking agents in other forms such as solids, such as powders, may be utilized consistently with the principles of the present invention, however.

Surfactants, such as defoamers, are also preferably included in the solidifier solutions 18 of the present invention. Surfactants may maintain the compatibility of the components in solution, or minimize foaming or coagulation of the ingredients. A surfactant maintains the viscosity of the solidifier solution 18, and enables it to be easily applied to sand, for example, by spraying. Preferably, a surfactant may be chosen to enhance the rate of curing once the solidifier solution 18 has been applied to the sub-base 16, to minimize coagulation, or to maintain or enhance the strength properties of the composite layer 20 as it forms with from the solidifier solution 18 and at least some of the sub-base layer 16. Preferably, the surfactant increases the wetting of the aqueous emulsion polymer solution, or the flow of the polymer over the sand upon application, enabling the mixture of the solidifier solution 18 and at least some of the sub-base layer 16 to be more easily formed into the desired shape of the pool bottom. Additionally, surfactants used in the present invention are preferably non-ionic, and a preferred ingredient in a surfactant of the present invention is ethylene oxide.

Solidifier solutions 18 of the present invention are typically formed by mixing, and preferably include an aqueous emulsion polymer, a cross-linking agent, a surfactant, and water, which acts as a diluent. Upon mixing, the solidifier solutions 18 of the present invention should remain sealed until just prior to their application.

One example of an aqueous emulsion polymer solution that may be used in the solidifier solutions 18 of the present invention may typically include water, an initiator, a surfactant, one or more monomers and an inhibitor. Preferably, this emulsion polymer solution is formed from approximately 45 to 70 percent (45-70%) by weight of water; approximately 25 to 55 percent (25-55%) by weight of one or more monomers; approximately 0.1 to 3 percent (0.1-3%) by weight of an initiator; approximately 0.1 to 3 percent (0.1-3%) by weight of a surfactant; and approximately 50 to 3,500 parts per million (50-3,500 ppm) by weight of an inhibitor. The mass percentages of the initiator, the surfactant and the inhibitor may be selected based on the type and mass of the monomers chosen for inclusion in the solution.

In the foregoing example, the monomers include a combination of butyl methacrylate, methyl methacrylate and/or methacrylic acid that is combined with styrene to form a styrene acrylate polymer with carboxylic acid functionality. Additionally, a preferred initiator is a persulfate, such as sodium persulfate, and a preferred surfactant is sodium dodecyl benzene sulfonate (SDS), in a 23 percent (23%) solution. A preferred inhibitor is 4-hydroxy-2,2,6,6-tetramethylpiperidinyloxy (4-hydroxy-TEMPO).

To prepare a batch of approximately 100 grams of the emulsion polymer solution described above, approximately 25 grams of water may be combined with 1 gram of the surfactant and approximately 50 grams of monomers in a vessel, such as a beaker, and mixed under high shear for approximately fifteen minutes to form a monomer emulsion. Next, in another vessel, a small amount of an initiator solution may be prepared using approximately 10 grams of water and 0.5 grams of an initiator, and set aside. In a reactor, such as a large flask, approximately 15 grams of water may be combined with approximately 0.5 grams of the initiator and stirred. The reactor may preferably include a paddle mixer and a thermometer. While stirring, the monomer emulsion may be added to the reactor at a rate of approximately 2 grams per minute, at a temperature of at least about 80 degrees Celsius (80° C.). The feed rate may be regulated as needed to maintain the temperature of the mixture above about 80° C. but below about 95° C. Once the feed of monomer emulsion into the flask is complete, the stirring may be held for approximately thirty minutes before adding inhibitor solution to the reactor and mixing for an additional thirty minutes. The batch may be filtered to remove any coagulum.

Once prepared, an emulsion polymer solution such as is described above may be combined with a cross-linking agent, such as a zinc ammonium complex, to form a solidifier solution of the present invention. Other emulsion polymers may be formed using procedures similar to that identified above. A preferred emulsion polymer solution may include approximately 69% water by weight; approximately 0.6% initiator by weight, approximately 0.6% surfactant by weight; approximately 0.1% inhibitor by weight; and approximately 30% monomers by weight. Such monomers may include approximately 0.4% butyl methacrylate, approximately 3.7% methyl methacrylate, approximately 0.1% methacrylic acid and approximately 25.7% styrene by weight, and may form a styrene acrylate copolymer with carboxylic acid functionality.

Another preferred emulsion polymer solution may include approximately 48% water by weight; approximately 1% initiator by weight; approximately 1% surfactant by weight; approximately 0.1% inhibitor by weight; and approximately 50% monomers by weight. Such monomers may include approximately 0.6% butyl methacrylate, approximately 6.2% methyl methacrylate, approximately 0.15% methacrylic acid and approximately 43% styrene by weight, and may form a styrene acrylate copolymer with carboxylic acid functionality.

Emulsion polymer solutions such as those that are prepared in a manner similar to that described above may be combined with water, a cross-linking agent, such as a zinc ammonium complex, and a defoamer, preferably a silicon-based defoamer, to form a solidifier solution of the present invention. For example, the solidifier solution may include approximately 60-90% (preferably 80%) emulsion polymer solution by weight; approximately 5-30% (preferably 18%) water by weight, approximately 1-10% (preferably 2%) cross-linking agent by weight, and about three drops of defoamer.

Preferred monomers which might be included in the solidifier solutions of the present invention include, alpha-methylstyrene; t-butyl styrene; vinyl toluene; 2-hydroxy ethyl methacrylate; 2-ethylhexyl methacrylate; hydroxymethyl methacrylate; hydroxypropyl methacrylate; benzyl methacrylate; lauryl methacrylate; oleyl methacrylate; palmityl methacrylate; stearyl methacrylate; acrylic acid; acryloxy propionic acid; methacryloxy propionic acid; itaconic acid; aconitic acid; maleic acid; maleic anhydride; fumaric acid; crotonic acid; monomethyl maleate; monoethyl fumerate; and monomethyl itaconate.

Preferred initiators which might be included in the solidifier solutions of the present invention include, oxidizers such as hydrogen peroxide, sodium persulfate, lithium persulfate, potassium persulfate and ammonium persulfate; or reducing agents such as sodium metabisulfite; lithium metabisulfite; potassium metabisulfite; sodium hypersulfite; lithium hypersulfite; potassium hypersulfite; sodium hydrosulfite; lithium hydrosulfite; potassium hydrosulfite; sodium formaldehyde sulfoxylate; ascorbic acid and isoascorbic acid.

Preferred surfactants which might be included in the solidifier solutions of the present invention include non-ionic surfactants such as tert-octylphenoxyethylpoly(39) ethoxyethanol; nonylphenoxyethyl-poly(10) ethoxyethanol; nonylphenoxyxyethyl poly(40) ethoxyethanol; polyethylene glycol 2000 monooleate; ehtoxylated castor oil; fluorinated alkyl esters; flourinated alkyl esters; flourinated alkoxylates; polyoxyethylene (20) sorbitan monolaurate; sucrose monococoate; di(2-butyl)phenoxypoly(20)ethoxy ethanol; hydroxyethylcellulosepolybutyl acrylate graft copolymer; dimethyl silicone polyalkylene oxide graft copolymer; poly (ethylene oxide) poly (butyl acrylate) block copolymer; block copolymers of propylene oxide and ethylene oxide; 2,4,7,9-tetramethyl-5-decyne-4,7-diol ethoxylated with 30 moles of ethylene oxide; N-polyoxyethylene (20) lauramide; N-lauryl-N-polyoxyethylene (3) amine; poly(10)ethylene glycol dodecylthioether. Some anionic surfactants that may be included in the solidifier solutions of the present invention include, sodium lauryl sulfate; sodium dodecylbenzene sulfonate; potassium stearate; sodium dioctylphenyl oxide disulfonate; sodium styrene sulfonate; sodium dodecyl allyl sulfosuccinate; and sodium phosphate ester.

Preferred inhibitors which might be included in the solidifier solutions of the present invention include N,N-diethylhydroxylamine; N-nitrosodiphenyl amine; 2,4-dinitrophynyl hydrazine; p-phenyl diamine; phenothiazine; allocimene; triethylphosphite; 4-nitrosophenol; 2-notophenol; p-aminophenol; hydroxyquinone; 2,5-di-tert-butyl-p-hydroquinone; 1,4 napthalenediol; copper sulfate; copper nitrate; cresol; and phenol.

In a preferred solution containing a styrene acrylate emulsion polymer solution, a zinc oxide solution containing ammonia as the cross-linking agent, and a standard surfactant with water as a diluent, the solidifier solution 18 remains slightly basic after mixing. When the solidifier solution 18 is isolated, such as in a sealed container, the ammonia in the cross-linking agent binds with the carboxylic acid functional groups in the acrylate emulsion polymer solution and prevents these groups from binding with zinc. Once the solidifier solution 18 is applied to a sub-base 16, for example by spraying, the solution begins to dry and harden. In the preferred solution, water and ammonia from the cross-linking agent are then released during the drying process, and the neutralized zinc remaining after ammonia is released acts as a source of cross-linking with the carboxylic acid groups of the styrene acrylate emulsion polymer in solution. As a result, the zinc cross-links the polymers to form a film as water and ammonia are released, and the pH of the remaining mixture is reduced as the film hardens.

Two representative embodiments of solidifier solutions of the present invention are described in greater detail below with reference to the following examples and test results.

### Example 1

A first solidifier solution (Example 1) was prepared using the acrylic-styrene emulsion polymer solution Acronal® 2835, which is produced by BASF Corporation, of Charlotte, N.C., as the monomer. Zinc Oxide #1 solution, which was produced by Johnson Polymer, of Sturtevant, Wis., was used as a cross-linking agent. Additionally, Surfynol® DF-66, which is produced by Air Products and Chemicals, Inc., of Allentown, Pa., was used as a surfactant.

Acronal® 2835 is an acrylic polymer latex with approximately 50% solids by weight, a viscosity of approximately 300 cps, a density of approximately 8.7 pounds per gallon, and a glass transition temperature of 20° C. Acronal® 2835 is a basic solution with a milky white liquid and an acrylic odor. Acronal® 2835 has a specific gravity of 1.1, a pH of approximately 9.0, and 47.5% volatile organic compounds by weight.

Zinc Oxide #1 comprises carbonic acid and salts of ammonium and zinc, such as zinc ammonium carbonate, in solution. Zinc Oxide #1 is a colorless liquid with an ammonia-like odor, and has a pH of approximately 11.0 to 12.0, and a specific gravity of approximately 1.21.

Surfynol® DF-66 is a liquid acetylenic-modified, polysiloxane-based defoamer, and includes polypropylene glycol as a principal ingredient. Surfynol® DF-66 is a white liquid with approximately 45.0 to 51.0% solids by weight, a viscosity of approximately 4,680 cps at 25° C., a specific gravity of approximately 1.006 (typical range of 0.991 to 1.021) at 25° C., and 2.6% volatile organic compounds by weight.

The Example 1 solution was formed by combining 70% Acronal® 2835, 10% Zinc Oxide #1 solution and 20% water by volume, plus approximately three drops of Surfynol® DF-66 as a defoamer. The Example 1 solution was formed by mixing the ingredients, and was subsequently sealed in a container prior to testing.

### Example 2

A second solidifier solution (Example 2) was prepared using the acrylic-styrene emulsion copolymer marketed under the name Texicryl® 13-061, which is produced by Scott Bader, Inc., Stow, Ohio, as the monomer. Zinc Oxide #1 was used as the cross-linking agent, and Surfynol® DF-66 was used as the surfactant.

Texicryl® 13-061 is a 50% styrene acrylic copolymer latex, modified to include silane incorporated into the polymer backbone, in order to improve its flexibility and water resistance. Texicryl® 13-061 has approximately 50% solids by weight, and a specific gravity of 1.02, a viscosity of 50-200 cps, a pH of 7.0 to 8.5, a glass transition temperature of 11° C. Texicryl® 13-061 also has a minimum film forming temperature of 0° C.

The Example 2 solution was formed using 80% Texicryl® 13-061, 2% Zinc Oxide #1 solution and 18% water by volume, plus approximately three drops of Surfynol® DF-66 as a surfactant. The Example 2 solution was formed by mixing the ingredients, and was subsequently sealed in a container prior to testing.

The tests of the Example 1 and Example 2 solutions were performed substantially identically, as follows. First, a bed of sand approximately one to two inches (1-2″) thick was applied to a sample area and was subsequently shaped by manual means. Next, the relevant solution to be tested was combined with water, at approximately a one-to-one (1:1) ratio. Water was applied to the sand bed to increase the moisture content consistently throughout the sand bed. The solution-water combination was then sprayed substantially evenly across the sand bed, and raked and troweled into the sand bed. The raking and troweling created a substantially homogenous mixture of the solution-water combination and a top layer of the sand bed, which was then finally smoothed and allowed to set.

Test Results

Both Example 1 and Example 2 formed a sufficiently hard and smooth surface within a relatively short period of time, thus enabling a liner to be promptly installed onto the solidified composite layer. However, Example 2's results were deemed superior to those of Example 1, for the mixture of Example 2 provided a harder composite layer than that of Example 1 after curing. It is believed that the use of Texicryl® 13-061, which has a lower pH than Acronal® 2835, enables the use of a smaller amount of cross-linking agent, which results in a smaller volume of ammonia being released as the solution dries and hardens. Minimizing the release of ammonia, which has a noxious odor, is generally preferred because the solidifier solutions of the present invention are intended for both indoor and outdoor use. Although the results obtained using the Example 2 solution were deemed superior to those obtained using the Example 1 solution, the Example 1 solution and other aqueous emulsion polymer solutions demonstrating characteristics similar to those disclosed herein may be used in accordance with the present invention, however.

The compounds and methods disclosed herein may be used to construct swimming pools with harder and smoother bottoms more quickly and efficiently than according to methods of the prior art. Additionally, the compounds and methods disclosed herein can fix a soil shape or form at any point during construction, thereby enabling workers to suspend their work for brief periods or overnight, and recommence their activity at a later time. In the particular example of a swimming pool, forming a sand pool bottom and installing a pool liner according to prior art methods requires workers to complete the job as quickly as possible after the pool bottom has been formed. Using a solidifier solution according to the present invention, however, the pool bottom may be formed in stages, without risking the loss of the pool bottom form due to creep or other deformation of the sand. Also, the concentration of the solidifier solution may be increased or decreased by known methods as necessary for the particular application. For example, a more dilute solution may be used to construct a shallow end of a pool bottom, while a stronger solution may be desired to construct the deep end of a pool bottom, because the shallow end will be subject to smaller hydrostatic pressures than the deep end. Additionally, the solidifier solutions of the present invention enable the installation of a liner into a pool bottom within 0 to 12 hours after application, depending on atmospheric and/or environmental conditions, and the methods and compounds disclosed herein may be used in both indoor and outdoor construction.

Moreover, as is set forth above, the methods and compounds disclosed herein may be used in a variety of applications and are not limited to use in swimming pool installations. For instance, the compounds may be used to fix the shape and form of prepared soil before installing a concrete structure, such as a cofferdam, flat slab or footing, or for any desired reason.

The solidifier solutions of the present invention may be used to stabilize a bank of soil, particularly sand, for any reason, including during construction applications or the like. Additionally, the chemical properties of the solution permit mixing it directly with pure sand (such as with a paddle mixer or by hand), and applying it to an edge of any masonry-type product that requires repair, such as a crack or other break. The combination of a solidifier solution of the present invention and sand, may eliminate the need to use cement, particularly if a crack or other break is sufficiently small. The solidifier solution may also be used in a number of applications and are not limited to the application to soil. For example, the solution may also be combined with cement or vermiculite, such as during the mixing or pouring stages, and can provide a marked increase in strength and density of a finished cement product.

Additionally, the solidifier solution need not be used solely with sand. Rather, the solidifier solution may be applied to sand substitutes or like materials, including but not limited to commonly known sand-like substances that are compatible with the solidifier solution, in accordance with the principles of the present invention.

It should be understood that, unless otherwise explicitly or implicitly indicated herein, any of the features, characteristics, alternatives or modifications described regarding a particular embodiment herein may also be applied, used, or incorporated with any other embodiment described herein. Also, it should also be understood that the accompanying drawings are not drawn to scale.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

As may be recognized by those of ordinary skill in the pertinent art based on the teachings herein, numerous changes and modifications may be made to the above-described and other embodiments of the present invention without departing from the spirit of the invention as defined in the claims. Accordingly, this detailed description of currently preferred embodiments is to be taken in an illustrative, as opposed to a limiting sense.

Although the invention has been described and illustrated with respect to exemplary embodiments thereof, the foregoing and various other additions and omissions may be made therein and thereto without departing from the spirit and scope of the present disclosure.

1. A solidifier solution comprising an aqueous polymer in solution, a cross-linking agent, and a surfactant.

2. The solidifier solution of claim 1, wherein the solidifier solution comprises approximately 60-90% aqueous polymer solution by weight; and approximately 1-10% cross-linking agent by weight.

3. The solidifier solution of claim 1, wherein the solidifier solution comprises approximately 45-70% water by weight; approximately 25-55% of at least one monomer solid by weight; approximately 0.1-3% of at least one initiator by weight; approximately 0.1-3% of at least one surfactant by weight; and approximately 50 to 3,500 parts per million of an inhibitor by weight.

4. The solidifier solution of claim 3, wherein the solidifier solution comprises approximately 69% water by weight; approximately 30% of the at least one monomer by weight; approximately 0.6% of the at least one initiator by weight; approximately 0.6% of the at least one surfactant by weight.

5. The solidifier solution of claim 4, wherein the at least one monomer comprises butyl methacrylate, methyl acrylate, methacrylic acid and styrene, and
wherein the solidifier solution comprises approximately 0.4% butyl methacrylate by weight; approximately 3.7% methyl methacrylate by weight; approximately 0.1% methacrylic acid by weight and approximately 25.7% styrene by weight.

6. The solidifier solution of claim 3, wherein the solidifier solution comprises approximately 48% water by weight; approximately 50% of the at least one monomer by weight; approximately 1% of the at least one initiator by weight; approximately 1% of the at least one surfactant by weight.

7. The solidifier solution of claim 6, wherein the at least one monomer comprises butyl methacrylate, methyl acrylate, methacrylic acid and styrene, and
wherein the solidifier solution comprises approximately 0.6% butyl methacrylate by weight; approximately 6.2% methyl methacrylate by weight; approximately 0.15% methacrylic acid by weight and approximately 43% styrene by weight.

8. The solidifier solution of claim 1, wherein the aqueous polymer is a styrene acrylate having carboxylic acid functionality.

9. The solidifier solution of claim 8, wherein the styrene acrylate having carboxylic acid functionality is formed by combining at least one of butyl methacrylate, methyl methacrylate and methacrylic acid with styrene.

10. The solidifier solution of claim 1, wherein the cross-linking agent comprises a divalent metal.

11. The solidifier solution of claim 10, wherein the divalent metal is zinc.

12. The solidifier solution of claim 10, wherein the cross-linking agent is a zinc ammonium complex.

13. The solidifier solution of claim 1, wherein the surfactant comprises sodium dodecyl benzyene sulfonate.

14. The solidifier solution of claim 1, further comprising a defoamer.

15. The solidifier solution of claim 1, further comprising an initiator.

16. The solidifier solution of claim 1, wherein the aqueous polymer comprises at least one monomer selected from the group consisting of alpha-methylstyrene; t-butyl styrene; vinyl toluene; 2-hydroxy ethyl methacrylate; 2-ethylhexyl methacrylate; hydroxymethyl methacrylate; hydroxypropyl methacrylate; benzyl methacrylate; lauryl methacrylate; oleyl methacrylate; palmityl methacrylate; stearyl methacrylate; acrylic acid; acryloxy propionic acid; methacryloxy propionic acid; itaconic acid; aconitic acid; maleic acid; maleic anhydride; fumaric acid; crotonic acid; monomethyl maleate; monoethyl fumerate; and monomethyl itaconate.

17. A method, comprising:
providing a layer of a material;
applying a solidifier solution to the layer; and
combining the solidifier solution and at least some of the material to form a mixture.

18. The method of claim 17, further comprising forming the mixture into a predetermined form.

19. The method of claim 17, wherein the material comprises sand.

20. The method of claim 17, wherein the solidifier solution comprises a styrene acrylate having carboxylic acid functionality.
